(19) United States
(12) Patent Application Publication
(10) Pub. No.: US 2013/0146354 A1
(43) Pub. Date: Jun. 13, 2013

(54) WIRE FITTING AND WIRE HARNESS

(71) Applicant: Sumitomo Wiring Systems, Ltd., Yokkaichi-city (JP)

(72) Inventor: Tatsuya Shimada, Yokkaichi-city (JP)

(73) Assignee: SUMITOMO WIRING SYSTEMS, LTD., Yokkaichi-city (JP)

(21) Appl. No.: 13/677,762

(22) Filed: Nov. 15, 2012

(30) Foreign Application Priority Data
Dec. 9, 2011 (JP) JP2011-269958

(51) Int. Cl. H02G 3/04; H01B 17/38

(52) U.S. Cl. CPC H02G 3/0418; H01B 17/38
USPC 174/72 A; 174/169

(57) ABSTRACT

A wire harness is provided, with which a wire fitting can be arranged in an irregular space that is three-dimensionally bent, and with which the number of man-hours for manufacturing the wire harness can be reduced. A wire fitting includes a base that is molded into an uneven plate shape and forms a wiring space, and a cover that is assembled to the base. The base includes a level wiring portion and a slanted wiring portion that extends along a plane that is slanted with respect to the plane along which the level wiring portion extends. The cover includes a level opposing wall portion opposing the level wiring portion and a slanted opposing wall portion that opposes the slanted wiring portion and extends along a plane that is slanted with respect to the plane along which the level wiring portion extends.

### CROSS-REFERENCE TO RELATED APPLICATIONS

This application claims priority to Japanese Patent Application No. 2011-269958 filed in Japan on Dec. 9, 2011, the entire disclosure of which is hereby incorporated by reference in its entirety.

### BACKGROUND

The exemplary embodiments described herein detail for illustrative purposes and are subject to many variations in structure and design. It should be emphasized, however, that the present invention is not limited to a particularly disclosed embodiment shown or described. It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting. The terms “a” and “an” herein do not denote a limitation of quantity, but rather denote the presence of at least one of the referenced item. The disclosure generally relates to a wire fitting that holds wires in a predetermined shape as well as a wire harness including the same.

Wire harnesses that are mounted to vehicles, such as automobiles or the like, often include a wire fitting made of resin to which wires are attached, and are laid out in a state in which the wires are held along a predetermined path by the wire fitting. For example, in an ordinary conventional wire harness, the wires are fastened to a plate-shaped or rod-shaped resin member by binder members such as adhesive tape or belt members. Thus, the wires are held in their predetermined shape.

What is particularly important concerning the shape of wire harnesses is that the wires extend to a predetermined length from a predetermined reference position that is close to their connection counterpart. Here, the connection counterpart may be an electrical component or a connector or the like that is provided at the end of other wires.

For example, in a wire harness that is arranged below a seat of an automobile, it is important that a connector at an end of the wires or a portion close to the connector is fastened to a predetermined position (reference position), so that the connector at the end of the wires reaches the component, such as a motor for driving the seat, or the connector of the other wires at just the right length.

It should be noted that it is often sufficient if, in the wire harness, the path of the wires up to the reference position is accommodated within a given region with a relative wide range of tolerance.

For example, the wire harness disclosed in JP 2010-27242A includes a wire fitting that is made of two plate-shaped resin members that are fixed to each other by heat-pressing in a state in which they sandwich a wire bundle. One of the resin members is a base member made of a flat plate-shaped bottom plate portion and ribs standing upright on the bottom plate portion. The other resin member is a plate-shaped cover member, in which through holes are formed into which the ribs of the base are inserted, and which is fixed to the bottom plate portion of the base member in a state in which it covers the base member.

In the wire harness disclosed in JP 2010-27242A, the wires are sandwiched between the base and the cover, which are formed extending along one plane. Moreover, in the wire fitting disclosed in JP 2010-27242A, the ribs on the base are formed on both sides of the wire paths, and function as guides for the wires.

JP 2010-27242A is an example of related art.

Now, in the location where the wire harness is laid out, for example below a seat in an automobile, there may be other components besides the wire harness, such as a mechanism or a motor for movably supporting the seat, for example. Therefore, in order to avoid contact with other components, the space that serves for placing the wire fitting of the wire harness may be an irregular space that is three-dimensionally bent rather than a sufficiently wide, flat space, for example.

However, the wire fitting of JP 2010-27242A extends overall along a single plane, so that it poses the problem that it is not suitable for being arranged in an irregular space within the automobile that is three-dimensionally bent.

If the wire fitting would be formed with a bent shape so that it could be placed in an irregular shape, then at least a portion of the base holding the wires would be slanted with respect to the horizontal direction. Therefore, a structure would be necessary that prevents the wires from slipping from the slanted portion of the base and sticking out therefrom. In the wire fitting of JP 2010-27242A, the ribs raised from the bottom plate portion of the base partition the wiring space into individual paths for the wires and prevent the wires from sticking out.

However, in the wire fitting of JP 2010-27242A, the ribs of the base are raised protruding into the wiring space where many of the wires pass, so that the wires arranged on the bottom plate portion of the base tend to be lifted up from the bottom plate portion and cross over the ribs. In the wire fitting of JP 2010-27242A, when wires lifted up from the bottom plate portion of the base cross over the ribs, then the cover cannot be properly put over the base.

Consequently, if the wire fitting of JP 2010-27242A is employed, a bothersome operation of laying out the wires while pushing the wires onto the base so that the wires do not cross over the ribs becomes necessary. That is to say, the wire fitting of JP 2010-27242A poses the problem of requiring a bothersome wire layout operation.

On the other hand, even though ordinary conventional wire harnesses have a high freedom regarding their shape, their manufacture requires large tools, such as drawing boards, a large number of resin members such as corrugated tubes, a large number of binder members for fastening the wires to the resin members, and a bothersome operation of attaching many components to the wires.

As explained above, conventional wire fittings and wire harnesses pose the problem that they are not suitable for protecting wires while holding them in an irregular three-dimensional state, or require a large number of components for their manufacture, a bothersome operation for handling them, and extensive tools.

### SUMMARY

To address the above and other problems, a novel wire harness may include a wire fitting that can be placed in an irregular space that is three-dimensionally bent, and with which the number of man-hours for producing the wire harness can be reduced.

A wire fitting according to a first aspect of an exemplary embodiment may include a base and a cover. The base may be made of a member that is molded into an uneven plate shape forming a wiring space, and has a wire fastening portion to which one or more wires can be fastened. The cover may be made of a member that is molded into an uneven plate shape, and is assembled to the base across the wiring space. Moreover, the base may include a level bottom plate portion, a slanted bottom plate portion and a first outer edge projecting portion. The level bottom plate portion may be formed extending along a plane that is parallel to a first plane. The slanted bottom plate portion may be continuous with the level bottom plate portion, and may be formed extending along a second plane that is slanted with respect to the first plane. The first outer edge projecting portion may be formed in a portion of the slanted bottom plate portion and projects from the slanted bottom plate portion forming a side wall without an undercut when viewed from a direction perpendicular to the first plane, the first outer edge projecting portion constituting a partition at an outer edge of the wiring space. The cover may include a level ceiling plate portion, a slanted ceiling plate portion and a second outer edge projecting portion. The level ceiling plate portion may be formed extending along a plane that is parallel to a third plane, the level ceiling plate portion being arranged opposite the level bottom plate portion across the wiring space. The slanted ceiling plate portion may be continuous with the level ceiling plate portion, and may be formed extending along a fourth plane that is slanted with respect to the third plane, the slanted ceiling plate portion being arranged opposite the slanted bottom plate portion across the wiring space. The second outer edge projecting portion may be formed at a location of the slanted ceiling plate portion opposite the first outer edge projecting portion, the second outer edge projecting portion projecting from the slanted ceiling plate portion toward the first outer edge projecting portion and forming a side wall without an undercut when viewed from a direction perpendicular to the third plane, constituting a partition at an outer edge of the wiring space together with the first outer edge projecting portion.

A wire fitting according to a second aspect of an exemplary embodiment may include the features of the wire fitting according to the first aspect of an exemplary embodiment. In the wire fitting according to the second aspect, the base member may further include a reinforcement step portion that is continuous from the level bottom plate portion to the slanted bottom plate portion and where the reinforcement step portion constitutes a step surface without an undercut when viewed from a direction perpendicular to the first plane.

A wire fitting according to a third aspect of an exemplary embodiment may include the features of the wire fitting according to the first or second aspect of an exemplary embodiment. In the wire fitting according to the third aspect, the base member and the cover member may be vacuum-molded flat plate-shaped resin members.

A wire fitting according to a fourth aspect of an exemplary embodiment may include the features of the wire fitting according to the third aspect of an exemplary embodiment. In the wire fitting according to the fourth aspect, the base member and the cover member may be vacuum-molded flat plate-shaped members made of polyvinylchloride, polypropylene or polyethylene-terephthalate.

The exemplary embodiments may also be regarded to reside in a wire harness including a wire fitting according to any of these aspects of the exemplary embodiments, as well as a wire to which the wire fitting is attached.

In one aspect of an exemplary embodiment, the wire fitting may protect the wires by accommodating them inside a wiring space between a base and a cover. Moreover, the wires arranged in the wiring space may be fastened to the plate-shaped base by a wire fastening portion arranged at a predetermined position of the base. Consequently, for the wires to which the wire fitting of an exemplary embodiment is attached, the length of the portion of the wires that is positioned outward of the portion fastened with the wire fastening portion is held at a constant length. That is to say, the shape of the wires may be held by the wire fitting such that the end of the wires reaches its connection counterpart at just the right length.

Moreover, in the wire fitting according to an aspect of an exemplary embodiment, the base and the cover each may include a level portion and a slanted portion that is formed slanted with respect to the level portion, so that the base and the cover are overall formed with a three-dimensionally bent shape. Therefore, the wire harness including the wire fitting according to this aspect of an exemplary embodiment is suitable for being arranged in an irregular space that is three-dimensionally bent within an automobile.

Moreover, in the wire fitting according to an aspect of an exemplary embodiment, the wiring space between the slanted bottom plate portion of the base and the slanted ceiling plate portion of the cover may be partitioned with respect to the outside of the wiring space by a first outer edge projecting portion and a second outer edge projecting portion opposing the same. The first outer edge projecting portion and the second outer edge projecting portion may prevent the wires from slipping and sticking out of the slanted bottom plate portion of the base.

Moreover, the first outer edge projecting portion and the second outer edge projecting portion partition the outer edge of the wiring space. Different to the ribs of the wire fitting of JP 2010-27242A, such a first outer edge projecting portion and second outer edge projecting portion are not easily crossed by the wires arranged in the wiring space, and do not become a factor that impedes the proper attachment of the cover to the base.

Consequently, in the operation of laying out the wires in the wiring space of the base, a layout over any path in the wiring space is allowable, and even if the wires are lifted up from the wiring portion, the wires may be accommodated in the wiring space between the cover and the base simply by pushing the cover onto the base. That is to say, a bothersome operation of laying out the wires while pushing the wires lifted up from the base onto the base is not necessary.

Moreover, the first outer edge projecting portion and the second outer edge projecting portion project forming a side wall without an undercut when seen from a direction that is perpendicular to the plane along which the level bottom plate portion and the level ceiling plate portion extend. Therefore, the base and the cover constituting the wire fitting according to an aspect of an exemplary embodiment may be manufactured with a simple molding process using a die that moves back and forth in only one direction and without a complicated molding process using a sliding die, for example with a single vacuum molding process. Consequently, with this aspect of an exemplary embodiment, the number of man-hours for manufacturing the wire fitting can be reduced.

As shown above, this aspect of an exemplary embodiment may provide a wire harness, whose wire fitting may be placed in an irregular space that is three-dimensionally bent, and with which the number of man-hours for attaching the wire fitting to wires can be reduced.

According to the second aspect of an exemplary embodiment, a reinforcement step portion that may be formed continuously from the level bottom plate portion to the slanted bottom plate portion increases the rigidity of the base of the wire fitting in order to hold the slant angle of the slanted bottom plate portion with respect to the level bottom plate portion. Consequently, the wire fitting according to the second aspect of an exemplary embodiment has a high performance of maintaining a constant shape (rigidity), even if it employs a plate material whose thickness is comparatively small in order to save space and reduce weight.

Generally, members obtained by vacuum-molding flat plate-shaped resin members can be manufactured more easily and at lower cost than members that are obtained by injection molding of resin. Consequently, with the third aspect of an exemplary embodiment, the manufacturing time and manufacturing costs for the wire fitting can be reduced. It should be noted that the flat plate-shaped base including the ribs disclosed in JP 2010-27242A cannot be obtained by vacuum-molding a flat plate-shaped member.

Moreover, if the wire fitting is vacuum-molded, then, depending on the application, it is preferable to use any of polyvinylchloride, which has superior fire retardancy, polypropylene, which has superior stretchability, or polyethylene-terephthalate, which has superior rigidity, as the resin material constituting the wire fitting.

### BRIEF DESCRIPTION OF THE FIGURES

FIG. 1 is a perspective view of a wire fitting 10 according to an embodiment of the invention;

FIGS. 2A, 2B, and 2C show three views of the wire fitting 10 in an exemplary embodiment;

FIG. 3 is a plan view of the base constituting the wire fitting 10 in an exemplary embodiment;

FIG. 4 is a plan view of the cover constituting the wire fitting 10 in an exemplary embodiment;

FIG. 5 is a plan view of a wire harness 100 according to an embodiment of the invention;

FIG. 6 is a plan view of the wire harness 100 in a state in which the cover is removed;

FIG. 7 is a cross-sectional view of a portion of the wire fitting 10 in an exemplary embodiment;

FIG. 8 is a cross-sectional view of a portion of the wire harness 100 in an exemplary embodiment;

FIG. 9 is a perspective view showing how the wires and a tie belt are fastened to a wire tie portion of the wire fitting 10 in an exemplary embodiment;

FIG. 10 is a front view of the wire tie portion to which the wires are fastened in an exemplary embodiment;

FIG. 11 is a perspective view of a connector support portion of the wire fitting 10 in an exemplary embodiment;

FIG. 12 is a perspective view of the portion of the connector at the end of the wires in an exemplary embodiment;

FIG. 13 is a front sectional view of the connector support portion to which the connector is fastened in an exemplary embodiment; and

FIG. 14 is a perspective view of a pedestal connector support portion of the wire fitting 10 in an exemplary embodiment.

### DETAILED DESCRIPTION OF THE EMBODIMENTS

The following is a description of embodiments of the invention, with reference to the accompanying drawings. The following embodiments are merely examples for working the invention, and are not meant to limit the technical scope of the invention.

### General Configuration

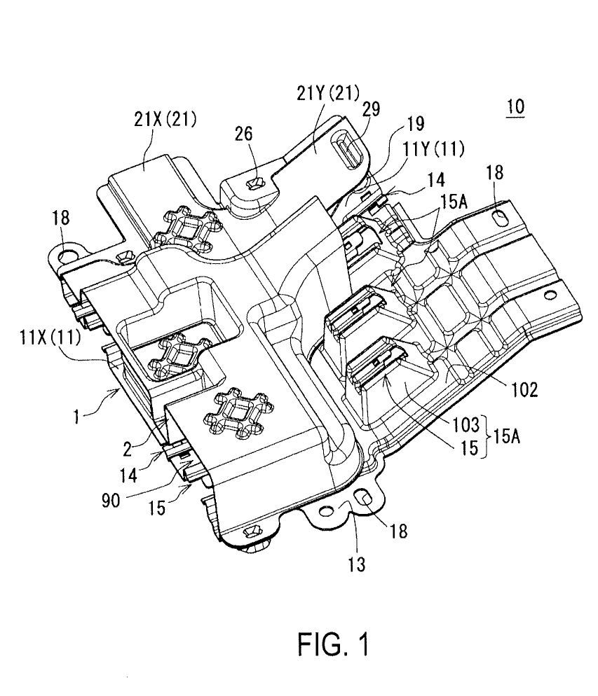

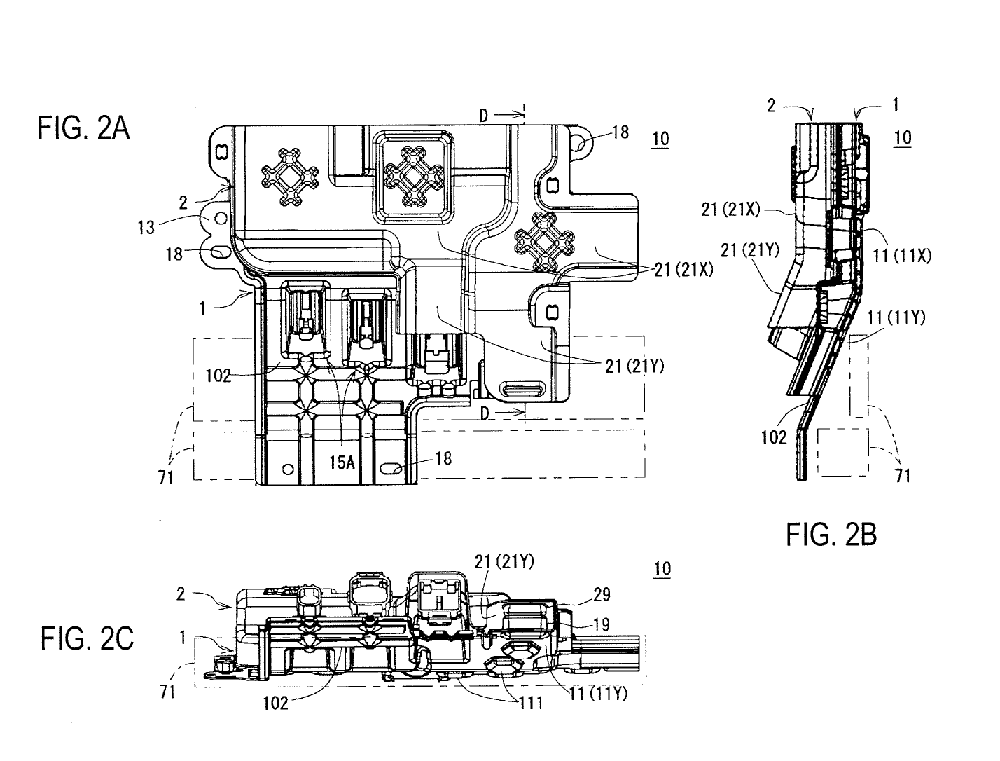

First, the general configuration of a wire fitting 10 in accordance with the exemplary embodiments and a wire harness 100 in accordance with an embodiment is explained with reference to FIGS. 1 to 7. FIG. 2A is a top view of the wire fitting 10, FIG. 2B is a side view of the wire fitting 10 and FIG. 2C is a front view of the wire fitting 10.

The wire harness 100 may include a bundle of wires made up of a plurality of electric wires 9 and the wire fitting 10, which is attached to this bundle of electric wires. The wire harness 100 may be attached, for example, in a space below the seats in a vehicle, a space behind the ceiling or in a trunk room or the like, and is connected to other wires or electric devices around it. For this reason, the wires 9 of the wire harness 100 may be wires with connectors that include an insulated wire and a connector 91 that is attached to an end of this insulated wire.

In the wire harness 100, the plurality of wires 9 may be bundled together by the wire fitting 10 in a state in which they are held in a predetermined shape. For this reason, the wire harness 100 can be easily attached at a predetermined position using a fastener, such as a clamp.

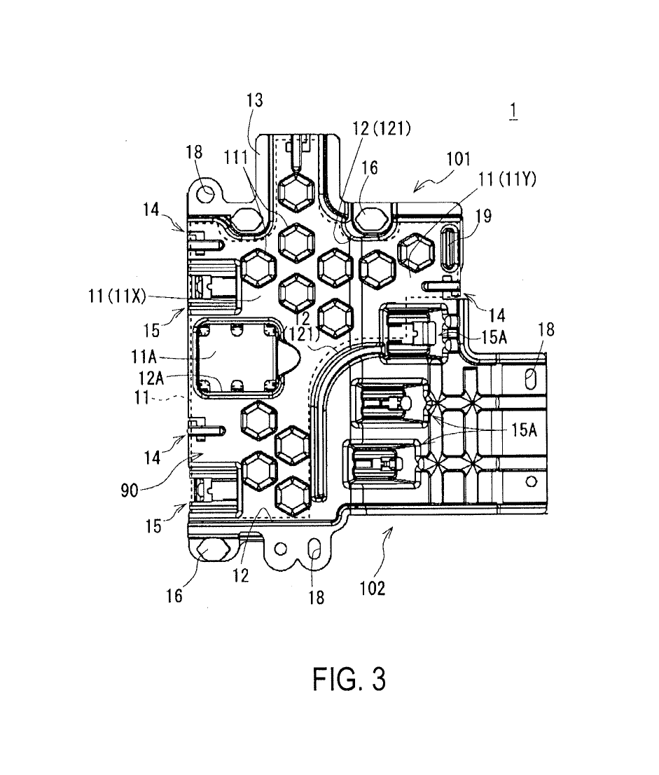

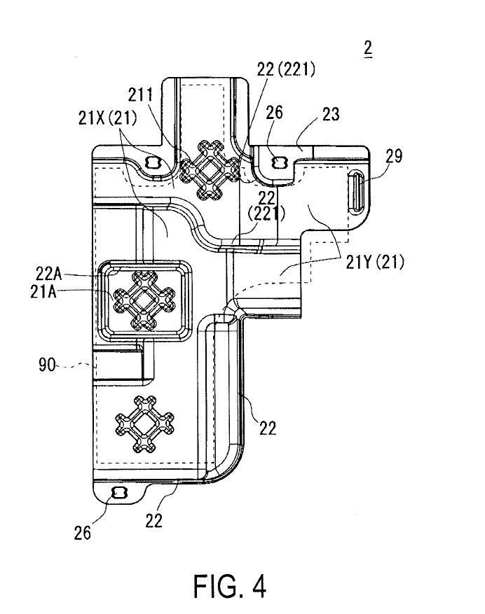

As shown in FIG. 1, the wire fitting 10 may include a base member 1 and a cover member 2 that is laid over the base. The cover member 2 is assembled to the base member 1 after tucking a mid portion of the plurality of wires 9 between the base member 1 and the cover member 2. FIG. 3 is a top view of the base member 1 and FIG. 4 is a top view of the cover member 2.

The base member 1 and the cover member 2 may be fixed to each other in a state in which the wires 9 are tucked in between them, and thus, the wire fitting 10 holds the wires 9 tucked between the base member 1 and the cover member 2 in their predetermined shape.

In the present embodiment, the base member 1 and the cover member 2 are separate members, but it is also conceivable that the base member 1 and the cover member 2 are constituted to be continuous through a connecting member that is elastically bendable.

In the present embodiment, the base member 1 and the cover member 2 of the wire fitting 10 are members that can be obtained by vacuum molding a plate-shaped resin member. The wire fitting 10 may be a resin member made of polypropylene (PP), polyethylene (PE), polyvinylchloride (PVC), polyethylene-terephthalate (PET), polyamide (PA) or the like.

Moreover, if the base member 1 and the cover member 2 are obtained by vacuum molding, then, depending on the application, polyvinylchloride (PVC), which has superior fire retardancy, polypropylene (PP), which has superior stretchability, or polyethylene-terephthalate (PET), which has superior rigidity, are preferable as the resin material constituting the base member 1 and the cover member 2. These resin materials are all materials that can be obtained easily and at low cost.

### Base

The base member 1 constituting the wire fitting 10 may be made by molding a resin member into an uneven plate shape. As noted above, the base member 1 in the present embodiment is obtained by vacuum-molding a flat plate-shaped resin member. As shown in FIG. 3, the base member 1 includes a wire protection portion 101 and an additional wire support portion 102.

The wire protection portion 101 may hold the wires that constitute the wire harness together with the wire fitting 10 in the predetermined shape and protects the wires. The cover member 2 may cover the wire protection portion 101 of the base member 1. On the other hand, the additional wire support portion 102 may support other wires than the wires constituting the wire harness together with the wire fitting 10. In the following, the wires supported by the additional wire support portion 102 are referred to as “additional wires”.

For example, the wire protection portion 101 may protect the wires that are connected to a device according to standard specification mounted to the automobile, whereas the additional wire support portion 102 supports some of the additional wires that are connected to an optional device of the automobile. Often, the additional wires are attached to the additional wire support portion 102 after the wire harness of the wire fitting 10 is attached to a support member, such as a frame below the seats. For this reason, the additional wire support portion 102 may be exposed without being covered by the cover member 2.

The wire protection portion 101 may include a wiring portion 11, a first step portion 12 and a first frame portion 13. In the base member 1 shown in FIG. 3, the region enclosed by the broken line is the region of the wiring portion 11. The first step portion 12 may be formed continuously with the outer edge of the wiring portion 11 and the inner edge of the first frame portion 13. The wiring portion 11 may be regarded as a bottom plate portion forming the bottom wall of the wire protection portion 101 in the base member 1.

The wiring portion 11 constituting the base member 1 may be a plate-shaped member facing a wiring space 90 in which the wires 9 are arranged. The wiring portion 11 may not be provided with partitions for partitioning the wiring space 90. However, a plurality of reinforcement recesses 111 forming indentations on the side facing the wiring space 90 may be formed across a comparatively wide portion of the wiring portion 11. These reinforcement recesses 111 are formed to increase the rigidity of the wiring portion 11.

The reinforcement recesses 111 formed in the wiring portion 11 may be portions formed by molding parts of the flat plate-shaped bottom plate portion forming the bottom wall of the wiring portion 11. Seen from the opposite site of the side facing the wiring space 90, the reinforcement recesses 111 may be projecting hollow portions. In the example shown in FIG. 3, the shape of the reinforcement recesses 111 corresponds to the shape from the bottom face of a regular six-sided pyramid to a cutting plane that is obtained by cutting the regular six-sided pyramid through a plane that is parallel to its bottom face. It should be noted that the reinforcement recesses 111 may also have another shape, for example, a columnar shape.

Instead of the reinforcement recesses 111, it is also possible that reinforcement protrusions that project to a height that is not greater than the height of the first step portion 12 are formed in the wiring portion 11. In this case, when seen from the opposite site of the side facing the wiring space 90, the reinforcement protrusions are recesses.

Moreover, the wiring portion 11 may include a level wiring portion 11X and a slanted wiring portion 11Y that is continuous with the level wiring portion 11X. These are described in detail further below.

At least a part of the first step portion 12 constituting the base member 1 may form a step along the outer edge of the wiring portion 11 and that is raised from the wiring portion 11 toward the wiring space 90. In other words, the outer edge of the wiring portion 11 may be formed along the inner edge of the first step portion 12.

As shown in FIGS. 3 to 6, a part of the first step portion 12 in the wire fitting 10 may be formed so as to enclose the four sides of a protection space 90A, which is a part of the wiring space 90. The protection space 90A may be a space in which a protected portion 41 is arranged that requires special protection more than the other portions of the wires, such as a portion where the core of the wires 9 is exposed or a device that is connected to the wires 9.

In the following explanations, the part of the first step portion 12 that is formed surrounding the protection space 90A is referred to as “partition wall portion 12A.” Moreover, the part of the wiring portion 11 facing the protection space 90A, that is, the part that is partitioned by the partition wall portion 12A is referred to as “protection chamber bottom plate portion 11A.”

In the present embodiment, the partition wall portion 12A may be a step portion that is formed by lowering a portion of the wiring portion 11 to a lower level, forming the protection space 90A. That is to say, the partition wall portion 12A may be a step portion that is formed by raising the protection chamber bottom plate portion 11A to the surrounding the wiring portion 11.

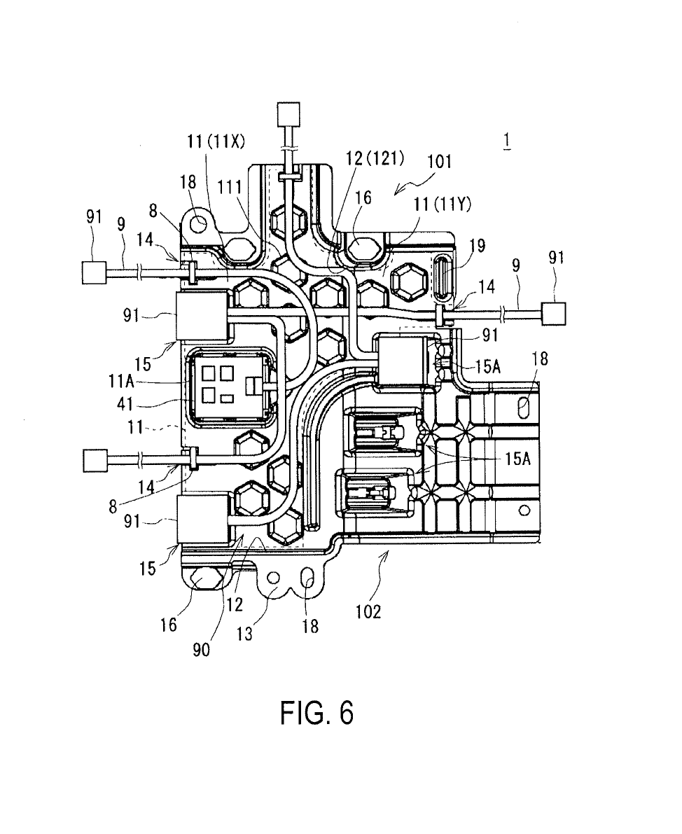

Moreover, in the example shown in FIG. 6, the protected portion 41 is an electronic wiring board that is connected to one of the wires 9. It is also conceivable that the protected portion 41 is a splice portion, which is a portion where the cores of a plurality of wires 9 are joined together by soldering.

Not all of the first step portion 12 is necessarily formed to the same height, and a part of it may include portions that are formed to be higher than other portions.

The first frame portion 13 constituting the base member 1 may be formed along the outer edge of the first step portion 12 and forms an outer edge portion of the base member 1. The first frame portion 13 may have a flat plate shape, but it is also conceivable that it has a shape in which recesses or protrusions are mixed with flat portions. In the present embodiment, the first frame portion 13 has a shape in which recesses and protrusions are mixed with flat portions.

Moreover, as shown in FIG. 3, the wiring portion 11 may be provided with wire tie portions 14 and connector support portions 15. Furthermore, the wiring portion 11 and the additional wire support portion 102 may be provided with pedestal connector support portions 15A that are made of pedestal portions 103 that project from the base portion and connector support portions 15 that are formed at the top of those pedestal portions 103. The connector support portions 15 and the pedestal connector support portions 15A are explained in detail further below.

Moreover, the first frame portion 13 may be provided with preliminary fixing recesses 16 and clamp holes 18. The wire tie portions 14 and the connector support portions 15 are portions to which some of the wires 9 arranged on the wiring portion 11 are fixed.

The clamp holes 18 are through holes through which clamps may be passed when the wire fitting 10 is attached to a support member, such as a panel of an automobile. By passing the clamps through the clamp holes 18 of the base member 1 and the attachment holes formed in the support members, the wire fitting 10 can be fastened to the support member.

The wire tie portions 14 and the connector support portions 15 are examples of wire fastening portions. A detailed explanation of the wire tie portions 14 and the connector support portions 15 as well as an explanation of the preliminary fixing recesses 16 formed in the base member 1 is given further below. In the following explanations, the wire tie portions 14 and the connector support portions 15 are collectively referred to as wire fastening portions 14, 15.

### Cover

The cover member 2 constituting the wire fitting 10 may be made by molding a resin member into an uneven plate shape. As noted above, like the base member 1, the cover member 2 in the present embodiment may be a vacuum-molded flat plate-shaped resin member. As shown in FIGS. 1, 2A, 2B, 2C, and 4, the cover member 2 may include an opposing wall portion 21, a second step portion 22 and a second frame portion 23. Furthermore, the cover member 2 also may include a plurality of preliminary fixing protrusions 26 that are formed in parts of the second frame portion 23. The second step portion 22 may be formed continuously with the outer edge of the opposing wall portion 21 and the inner edge of the second frame portion 23.

In the following explanations, it is assumed that, if explained in relation to the base member 1, the position or shape of the constituent elements of the cover member 2 is such that the cover member 2 is assembled covering the base member 1.

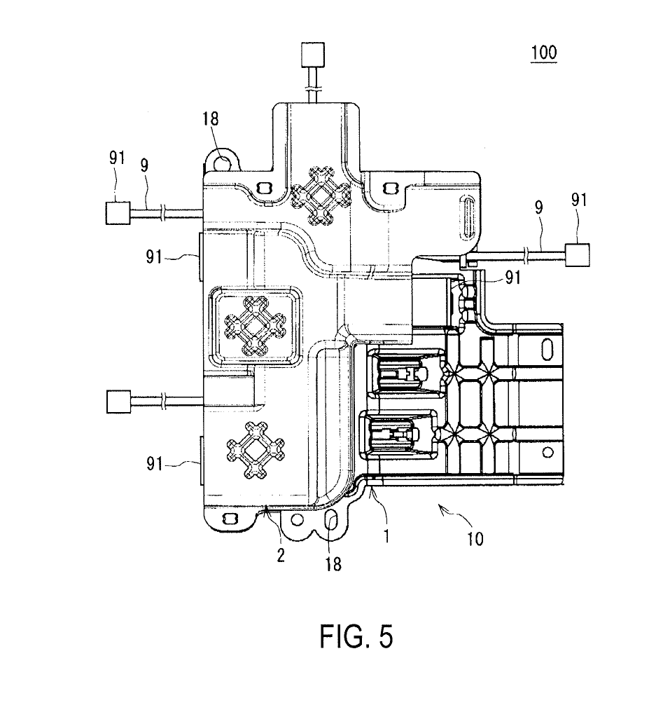

As shown in FIG. 5, the opposing wall portion 21 constituting the cover member 2 may oppose the wiring portion 11 of the base member 1 across the wiring space 90. The opposing wall portion 21 may not be provided with partitions for partitioning the wiring space 90. In FIG. 4, the region of the wiring space 90 covered by the cover member 2 is marked by a broken line.

The opposing wall portion 21 of the cover member 2 may be regarded as a ceiling plate portion that is arranged in opposition to the wiring portion 11 (bottom plate portion) of the base member 1 across the wiring space 90. However, the wire fitting 10 does not necessarily have to be attached to the support member with the base member 1 on the lower side, and may be attached in various orientations with regarded to the support member. That is to say, the term “bottom plate portion” means nothing more than the side with the wire fastening portions 14, 15, and is not a term specifying the vertical direction. Similarly, also the term “ceiling plate portion” means nothing more than the side opposite the bottom plate portion (the side of the base member 1) relative to the wiring space 90, and is not a term specifying the vertical direction.

In the present embodiment, the opposing wall portion 21 may be provided with reinforcement recesses 211 similar to the reinforcement recesses 111 in the wiring portion 11 of the base member 1. Seen from the wiring space 90 (the side of the base member 1), the reinforcement recesses 211 are recesses, but on the side opposite to the wiring space 90, they are hollow protrusions.

A part of the second step portion 22 constituting the cover member 2 may form a step along the outer edge of the opposing wall portion 21 and that is raised from the opposing wall portion 21 toward the side of the base member 1. In other words, a part of the outer edge of the opposing wall portion 21 may be formed along the inner edge of a part of the second step portion 22.

Moreover, the second step portion 22 may also be formed at an intermediate portion of the opposing wall portion 21. Thus, the wiring space 90, which may be formed between the wiring portion 11 of the base member 1 and the opposing wall portion 21 of the cover member 2, may be formed with differing heights depending on the region.

Not all of the second step portion 22 is necessarily formed to the same height, and a part of it may include portions that are formed to be higher than other portions. Moreover, the second frame portion 23 may have a flat plate shape, but it is also conceivable that it has a shape in which recesses or protrusions are mixed with flat portions. In the example shown in FIGS. 1, 2A, 2B, 2C, and 4, a part of the second frame portion 23 is provided with protrusions that protrude toward the base member 1. The preliminary fixing protrusions 26 formed in the cover member 2 are explained further below.

The opposing wall portion 21 of the cover member 2 may include a level opposing wall portion 21X and a slanted opposing wall portion 21Y that may be formed continuously with the level opposing wall portion 21X. These are described in detail further below.

Moreover, a part of the second step portion 22 of the cover member 2 may be formed so as to enclose a portion in the opposing wall portion 21 that opposes the protection chamber bottom plate portion 11A of the base member 1. In the following, the part of the opposing wall portion 21 that opposes the protection chamber bottom plate portion 11A of the base member 1 is referred to as “protection chamber ceiling portion 21A.” Moreover, the part of the second step portion 22 of the cover member 2 that is formed along the outer edge of the protection chamber ceiling portion 21A is referred to as “ceiling support portion 22A.”

Moreover, the portion of the protection chamber ceiling portion 21A and the ceiling support portion 22A in the cover member 2 may constitute a lid portion 24 that is formed protruding toward the base member 1. This lid portion 24 may be fitted to the inner side of the partition wall portion 12A of the base member 1 and may shut an opening formed by the partition wall portion 12A. The ceiling support portion 22A may form a step along the inner wall of the partition wall portion 12A. Thus, the opening formed by the partition wall portion 12A may be shut with high tightness by the lid portion 24.

Moreover, it is conceivable that a coating agent such as a resin or rubber is filled into the protection space 90A on the inner side of the partition wall portion 12A where the protected portion 41 is arranged. Thus, the effect of keeping dust and water away from the protected portion 41 can be improved.

Slanted Wiring Portion and Slanted Opposing Wall portion

As noted above, the wiring portion 11 may include a level wiring portion 11X and a slanted wiring portion 11Y that may be formed continuously with the level wiring portion 11X. Similarly, the opposing wall portion 21 may include a level opposing wall portion 21X and a slanted opposing wall portion 21Y that may be formed continuously with the level opposing wall portion 21X.

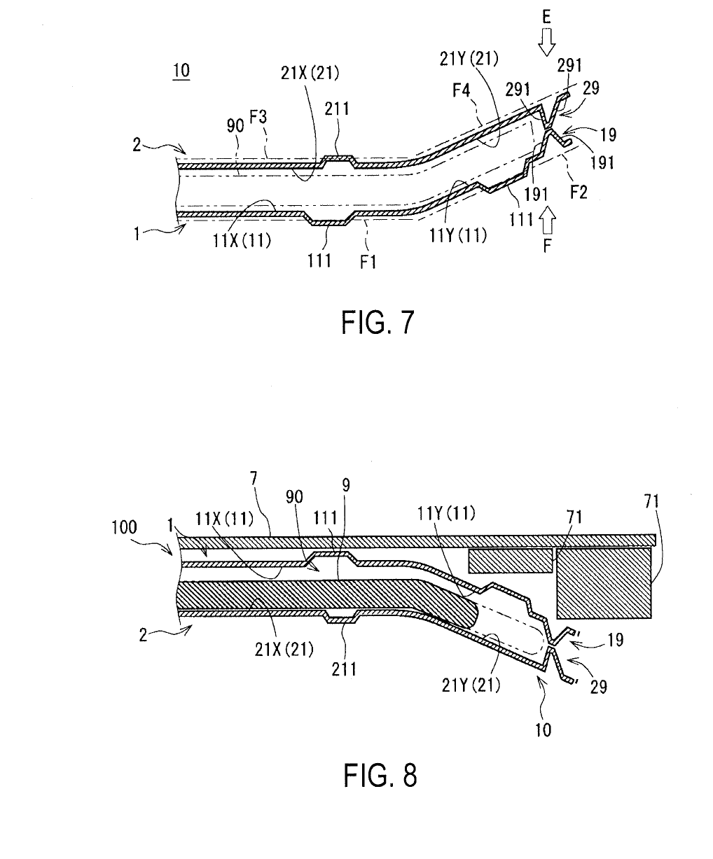

FIG. 7 is a cross-sectional view of the wire fitting 10 taken along the plane D-D shown in FIG. 2A. The level wiring portion 11X is the part of the wiring portion 11 that may be formed along a plane that is parallel to a first plane F1. On the other hand, the slanted wiring portion 11Y is the part of the wiring portion 11 that may be formed along a second plane F2 that is slanted with respect to the first plane F1.

Moreover, the level opposing wall portion 21X is the part of the opposing wall portion 21 that may be formed along a plane that is parallel to a third plane F3 and may be arranged in opposition to the level wiring portion 11X across the wiring space 90. On the other hand, the slanted opposing wall portion 21Y is the part of the opposing wall portion 21 that may be formed along a fourth plane F4 that is slanted with respect to the third plane F3, and may be arranged in opposition to the slanted wiring portion 11Y across the wiring space 90.

The third plane F3 is ordinarily substantially parallel to the first plane F1. Also, the fourth plane F4 is ordinarily substantially parallel to the second plane F2. Moreover, even if the fourth plane F4 is not parallel to the second plane F2, at least if the second plane F2 is slanted with respect to the first plane F1 towards the wiring space 90, then the fourth plane F4 is slanted with respect to the third plane F3 to the side opposite of the wiring space 90. Similarly, if the second plane F2 is slanted with respect to the first plane F1 to the side opposite of the wiring space 90, then the fourth plane F4 is slanted with respect to the third plane F3 toward the wiring space 90.

Note that the level wiring portion 11X, the slanted wiring portion 11Y, the level opposing wall portion 21X and the slanted opposing wall portion 21Y are respectively examples of a level bottom plate portion, a slanted bottom plate portion, a level ceiling plate portion and a slanted ceiling plate portion.

Moreover, as shown in FIGS. 1, 2C and 3, a part of the slanted wiring portion 11Y may project from to the portions surrounding it, and may be provided with a first outer edge projecting portion 19 constituting a partition at the outer edge of the wiring space 90.

On the other hand, the position of the slanted opposing wall portion 21Y opposite the first edge projecting portion 19 may be provided with a second outer edge projecting portion 29. This second outer edge projecting portion 29 projects from the portions surrounding the slanted opposing wall portion 21Y toward the first edge projecting portion 19, and may constitute a partition of the outer edge of the wiring space 90 together with the first edge projecting portion 19.

As shown in FIG. 7, the first edge projecting portion 19 may project and form a side wall 191 without an undercut when viewed from a direction E that is perpendicular to the first plane F1. Similarly, the second outer edge projecting portion 29 may project and form a side wall 291 without an undercut when viewed from a direction F that is perpendicular to the third plane F3.

It should be noted that all of the first step portion 12 in the base member 1 may form a step wall surface without an undercut when viewed from the direction E that is perpendicular to the first plane F1. Similarly, all of the second step portion 22 in the cover member 2 may form a step wall surface without an undercut when viewed from the direction F that is perpendicular to the third plane F3.

Also, as shown in FIG. 3, in the base member 1, a first connecting step portion 121 that is a part of the first step portion 12 may be formed continuously from the level wiring portion 11X to the slanted wiring portion 11Y. Also, as shown in FIG. 4, in the cover member 2, a second connecting step portion 221 that is a part of the second step portion 22 may be formed continuously from the level opposing wall portion 21X to the slanted opposing wall portion 21Y.

### Preliminary Fixing Mechanism

A part of the first frame portion 13 of the base member 1 may be provided with a plurality of preliminary fixing recesses 16. The preliminary fixing recesses 16 may form indentations that are open toward the cover member 2. It is preferable that the preliminary fixing recesses 16 are formed in the first frame portion 13 near the wire tie portions 14.

On the other hand, the second frame portions 23 in the cover member 2 may be provided with a plurality of preliminary fixing protrusions 26 that respectively fit into the preliminary fixing recesses 16 in the base member 1. The plurality of preliminary fixing protrusions 26 may be respectively formed at positions opposing the plurality of preliminary fixing recesses 16. Seen from the side of the base member 1, the preliminary fixing protrusions 26 may be protrusions, but seen from the opposite side with respect to the base member 1, they may be recesses.

In the wire fitting 10, the preliminary fixing recesses 16 formed in a part of the base member 1 and the preliminary fixing protrusions 26 formed in a part of the cover member 2 may constitute a preliminary fixing mechanism for fixing the cover member 2 to the base member 1.

The outer shape of the side walls of the preliminary fixing protrusions 26 may be formed to a shape that is inscribed by the inner walls of the preliminary fixing recesses 16 when slightly compressed. Thus, when the preliminary fixing protrusions 26 are pushed into the preliminary fixing recesses 16, the cover member 2 is fixed with respect to the base member 1 in a state in which it covers the wiring portion 11 of the base member 1, due to the friction resistance between the side walls of the preliminary fixing protrusions 26 and the inner walls of the preliminary fixing recesses 16.

As has been shown above, the preliminary fixing recesses 16 and the preliminary fixing protrusions 26 constitute a preliminary fixing mechanism that may fix the cover member 2 to the base member 1 in a state in which the cover member 2 covers the wiring portion 11, through a structure in which protrusions are fitted into recesses.

In the example shown in FIG. 1, the preliminary fixing recesses 16 are provided on the side of the base member 1, and the preliminary fixing protrusions 26 are provided on the side of the cover member 2, but the converse configuration is also possible. That is to say, the preliminary fixing recesses 16 may be provided on the side of the cover member 2, and the preliminary fixing protrusions 26 may be provided on the side of the base member 1. It is also possible to mix the preliminary fixing recesses 16 and the preliminary fixing protrusions 26 in the base member 1 and the cover member 2.

### Wire Harness

As shown in FIGS. 5 and 6, in the wire harness 100, the mid portions of the plurality of wires 9 may be arranged on the wiring portion 11 of the base member 1. Moreover, the connectors 91 at one end of some of the wires 9 may be fastened to the connector support portions 15 of the base member 1.

Moreover, the connectors 91 at the end of other wires 9 may be arranged outside the base member 1, and the mid portion of the wires 9 that is connected to those connectors 91 may lead from the wiring portion 11 of the base member 1 to the outside of the base member 1. Moreover, those wires 9 may be fastened by tie belts 8 to the wire tie portions 14.

Moreover, as shown in FIG. 5, the base member 1 and the cover member 2 may be assembled and fixed in a state in which the mid portion of the plurality of wires 9 arranged on the wiring portion 11 is sandwiched in the wiring space 90 between the wiring portion 11 and the opposing wall portion 21. In the present embodiment, the portion where the preliminary fixing recesses 16 and the preliminary fixing protrusions 26 are in contact with each other may be welded by a spot-heating device, such as by ultrasound welding, fixing the cover member 2 to the base member 1 and forming a welded portion between the preliminary fixing protrusions and the preliminary fixing recesses. Thus, the cover member 2 may be assembled to the base member 1 and may be held in a state in which the mid portion of the plurality of wires 9 is sandwiched between the base member 1 and the cover member 2,

For example, when the preliminary fixing protrusions 26 are fitted into the preliminary fixing recesses 16, the bottom surfaces of the preliminary fixing recesses 16 may be in contact with the top surfaces of the preliminary fixing protrusions 26. In this case, the welded portions may be formed at the portion where the bottom surfaces of the preliminary fixing recesses 16 are in contact with the top surfaces of the preliminary fixing protrusions 26.

### Wire Tie Portions

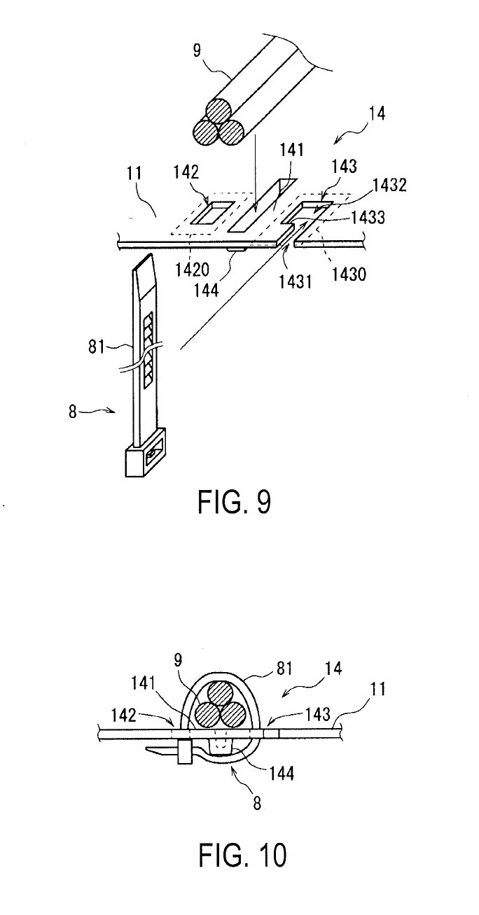

The following is an explanation of the wire tie portions 14, referring to FIGS. 9 and 10. FIG. 9 is a perspective view showing how the wires 9 and a tie belt 8 may be fastened with the wire tie portion 14 of the wire fitting 10. FIG. 10 is a front view of the wire tie portion 14 with which the wires 9 may be fastened. In FIGS. 9 and 10, the ends of the wires 9 are omitted and the cross section of the wires 9 is shown.

As shown in FIG. 9, the wire tie portion 14 of the present embodiment may include a wire passing portion 141, a first belt passing portion 1420 and a second belt passing portion 1430 in the wiring portion 11. The wire passing portion 141 may be the portion of the first frame portion 13 through which the wires 9 pass. In the wiring portion 11, the first belt passing portion 1420 may be next to the wire passing portion 141, and the second belt passing portion 1430 may also be next to the wire passing portion 141, but on the side opposite to that of the first belt passing portion 1420.

In the first belt passing portion 1420, a through hole 142 may be formed through which a belt portion 81 of the tie belt 8 may be passed. The belt portion 81 of the tie belt 8 that ties the wires 9 and the wire passing portion 141 together can be passed through this through hole 142. Consequently, the through hole 142 may be formed with such a size that the belt portion 81 of the tie belt 8 can be passed through it. It should be noted that the tie belt 8 is an example of a tie member, and the belt portion 81 is the portion of the tie belt 8 that may be wrapped around the object to be tied.

Moreover, the second belt passing portion 1430 may have a width that is larger than the thickness of the belt portion 81 of the tie belt 8, and may be a portion where a cut-in portion 143 is formed by cutting inward from the outer edge of the wiring portion 11. The cut-in portion 143 may be formed in a portion of the wiring portion 11 that is next to the wire passing portion 141 on the side that is opposite to that where the through hole 142 is positioned.

The through holes 142 and the cut-in portion 143 may be formed, for example, by punching of a flat plate-shaped resin member prior to vacuum molding.

In the example shown in FIG. 9, the cut-in portion 143 may be made of a slit-shaped outer hole portion 1431, which is cut inward from the outer edge of the wiring portion 11, and an inner hole portion 1432, which is a hole that is connected to the outer hole portion 1431 and has a width that is larger than the width of the outer hole portion 1431.

The inner hole portion 1432 may be formed at a position opposite to the through hole 142, with the wire passing portion 141 may be arranged therebetween, and is formed such that its width becomes larger from the outer hole portion 1431 towards the wire passing portion 141. Therefore, a step 1433 may be formed at the boundary portion between the edge of the outer hole portion 1431 on the side of the wire passing portion 141 and the edge of the inner hole portion 1432 on the side of the wire passing portion 141. That is to say, the inner hole portion 1432 may be formed such that its width becomes larger from the outer hole portion 1431 towards the wire passing portion 141 through the step 1433.

The tie belt 8 may first be passed from the outer hole portion 1431 in the cut-in portion 143 to the inner hole portion 1432. After that, the tip of the tie belt 8 may be passed through the through hole 142, and may be wrapped around wire passing portion 141 and the wires 9 placed on the wire passing portion 141.

As shown in FIG. 10, the tie belt 8 attached in this manner may be held in a state in which the wires 9 and the wire passing portion 141 are tied together, and the wires 9 may be fixed to the wire passing portion 141 of the wire tie portion 14.

In the wire tie portion 14 shown in FIG. 9, the edge portion of the through hole 142 and the step 1433 of the cut-in portion 143 may prevent tie belt 8 from moving position with respect to the wires 9 due to vibrations or the like, and that the tie belt 8 may come off the wiring portion 11. Therefore, the wires 9 may be fastened securely and firmly at the wire tie portion 14. Moreover, there may only be one operation of inserting the front end of the tie belt 8 into a through hole, and the number of man-hours of the tying operation may be reduced compared to the case of passing the tie belt 8 through two through holes.

Moreover, the portion of the wire passing portion 141 between the through hole 142 and the cut-in portion 143 may be provided with a projection 144 that projects from the surface opposite to the side where the wires 9 are laid out (the side of the wiring space 90). As shown in FIG. 10, also the projection 144 may be tied together with the wires 9 by the tie belt 8.

The following examples are also conceivable as other examples of a wire tie portion 14 that can be applied to the wire fitting 10. A wire tie portion according to another example may include the wire passing portion 141 of the wiring portion 11 and a portion in which two through holes are formed in the first frame portion 13 adjacently on both sides of the wire passing portion 141. In this case, the two through holes are holes through which the tie belt 8 tying the wires 9 and the wire passing portion 141 together may be passed.

### Connector Support Portions

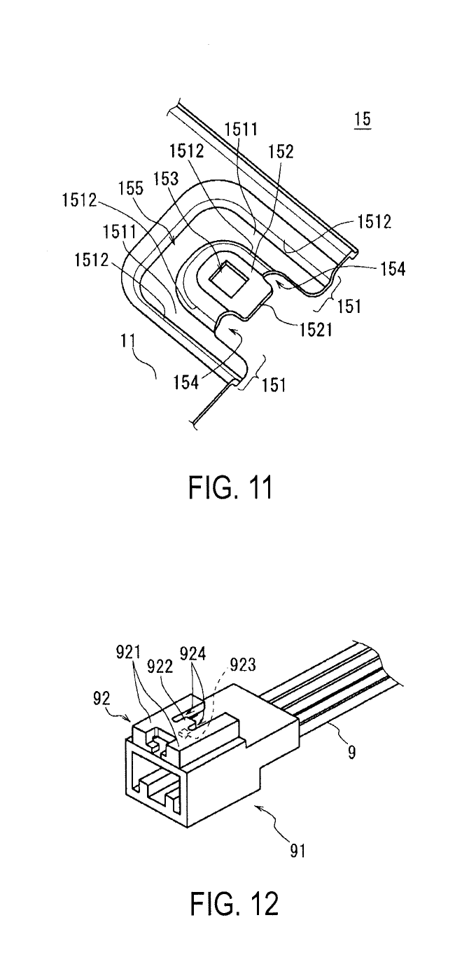

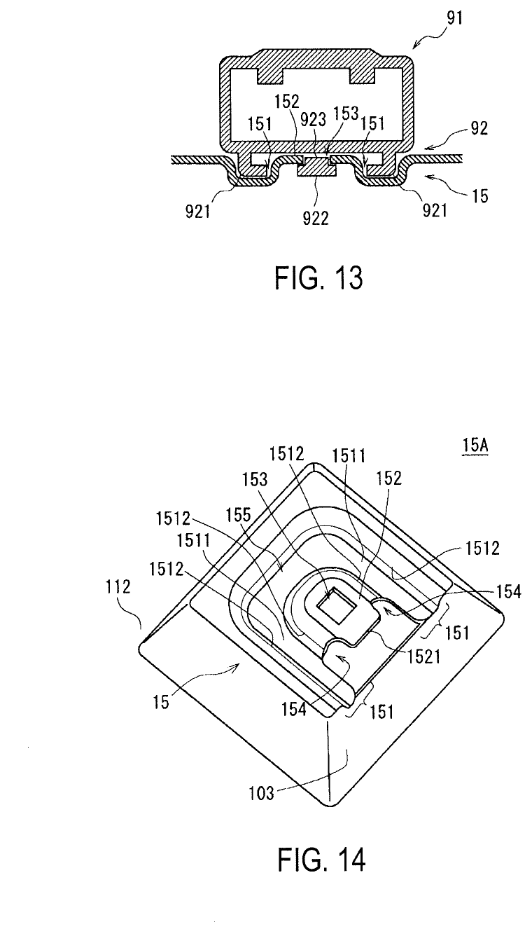

The following is an explanation of the connector support portions 15, with reference to the FIGS. 11 and 13. FIG. 11 is a perspective view of one of the connector support portions 15 in the wire fitting 10. FIG. 12 is a perspective view of a portion of one of the connectors 91 at the end of the wires 9. FIG. 13 is a front cross-sectional diagram of a connector support portion 15 to which a connector 91 is fastened.

Before describing the connector support portions 15, the structure of the connectors 91 fastened to the connector support portions 15 is explained.

As shown in FIG. 12, the connectors 91 at the end of the wires 9 may each include a coupling portion 92 to which another member, such as a clamp or the like, is coupled. The coupling portion 92 may include a pair of parallel guide rail portions 921 that form a gap into which a part of a coupled counterpart member can be fitted, and a bridge portion 922 bridging the pair of guide rail portions 921.

On a wall of the bridge portion 922 that is opposite to the bottom wall of the main body of the connector 91, a protrusion 923 may be formed that protrudes toward the main body of the connector 91.

The pair of guide rail portions 921 may protrude from an outer surface of the connector 91, and may form a pair of parallel protrusions that are formed extending in parallel lines. The bridge portion 922 may form a beam portion between the pair of guide rail portions 921 at a distance to the outer surface of the connector 91. Moreover, the protrusion 923 may form a ridge protruding from the bridge portion 922 towards the outer surface of the connector 91.

The connector 91 shown in FIG. 12 is widely used in wire harnesses installed in automobiles. Generally, the counterpart member to the coupling portion 92 may include a fitting piece that fits into the gap formed by the pair of guide rail portions 921 in the coupling portion 92. This fitting piece may be provided with a hole into which the protrusion 923 of the coupling portion 92 is fitted when the fitting piece is fitted into the gap of the pair of guide rail portions 921. By fitting the fitting piece into the gap of the pair of guide rail portions 921, the coupling portion 92 and the counterpart member may be held in a state in which they are coupled together.

On the other hand, as shown in FIG. 11, the connector support portion 15 of the present embodiment may be provided with a pair of parallel recesses 151 and an intermediate plate portion 152, which may be a portion between the pair of parallel recesses 151.

In the connector support portion 15, the pair of parallel recesses 151 may be a portion where a pair of parallel groves are formed that extend linearly inward from the outer edge of the first frame portion 13 in the base member 1. More specifically, they may include a bottom plate portion 1511 that extends linearly from the outer edge to the inside of the first frame portion 13, and two side wall portions 1512 that are formed continuously with the bottom plate portion 1511 on both sides of the bottom plate portion 1511. The side wall portions 1512 may form a step that rises from the bottom plate portion 1511 on both sides of the bottom plate portion 1511. The pair of guide rail portions 921 on the coupling portion 92 of the connector 91 may be fitted to the pair of grooves formed by the pair of parallel recesses 151.

Moreover, in the connector support portion 15, the intermediate plate portion 152 may be a plate-shape portion arranged between the pair of parallel recesses 151, and may be the portion that is inserted into the gap between the outer surface of the main end portion of the connector 91 and the bridge portion 922 of the coupling portion 92. In the present embodiment, the intermediate plate portion 152 may be flat plate-shaped.

Moreover, the intermediate plate portion 152 may be provided with a hole 153 into which the protrusion 923 formed at the bridge portion 922 may be fitted when the intermediate plate portion 152 is inserted into the gap between the outer surface of the main body portion of the connector 91 and the bridge portion 922 of the coupling portion 92.

As shown in FIG. 13, in the state in which the connector 91 is fastened to the connector support portion 15, the pair of guide rail portions 921 at the coupling portion 92 of the connector 91 may be fitted into the pair of parallel recesses 151 at the connector support portion 15. Furthermore, the intermediate plate portion 152 of the connector support portion 15 may be inserted into the gap between the outer surface of the main body portion of the connector 91 and the bridge portion 922 of the coupling portion 92, and the protrusion 923 formed at the bridge portion 922 of the coupling portion 92 may be fitted into the hole 153 formed in the intermediate plate portion 152.

In the connector support portion 15, the pair of parallel recesses 151 may limit the movement of the connector 91 in the direction perpendicular to the longitudinal direction of the grooves of the pair of parallel recesses 151. Moreover, since the intermediate plate portion 152 may be inserted into the gap between the outer surface of the main body portion of the connector 91 and the bridge portion 922 of the coupling portion 92, it may limit the movement of the connector 91 in the depth direction of the grooves of the pair of parallel recesses 151. Furthermore, the edge of the hole 153 in the intermediate plate portion 152 may limit the movement of the connector 91 in the longitudinal direction of the grooves of the pair of parallel recesses 151.

Moreover, in the present embodiment, cut-in portions 154 that are cut inward may be formed at the border between the two sides of the intermediate plate portion 152 and the respective parallel recesses 151. Thus, at the end of the intermediate plate portion 152, the outer edge of the first frame portion 13 may be provided with an eaves portion 1521 that protrudes like a cantilevered beam.

At the coupling portion 92 of the connector 91 shown in FIG. 12, gaps 924 may be formed between the bridge portion 922 and the respective guide rail portions 921, and a part of the side wall portions 1512 of the pair of parallel recesses 151 may be inserted into those gaps 924. In this case, the connector support portion 15 does not necessarily have to be provided with the cut-in portions 154.

In the present embodiment, the cut-in portions 154 may be formed on both sides of the intermediate plate portion 152 in such a manner that the intermediate plate portion 152 is inserted deeper into the gap between the outer surface of the main body portion of the connector 91 and the bridge portion 922 of the coupling portion 92. Thus, the intermediate plate portion 152 may latch on in a more stable manner with respect to the bridge portion 922, and the connector 91 may come off less easily from the connector support portion 15.

However, if no gaps 924 are formed in the coupling portion 92 of the connector 91, then it may be necessary that the cut-in portions 154 are formed in the connector support portion 15. This way, it may become possible to insert the intermediate plate portion 152 into the gap between the outer surface of the main body portion of the connector 91 and the bridge portion 922 of the coupling portion 92.

Moreover, in the coupling portion 92 of the connector 91 shown in FIG. 12, an inner recess 155 may be furthermore formed in a portion forming a groove that connects the pair of grooves formed by the pair of parallel recesses 151, further inward than the intermediate plate portion 152. This inner recess 155 may have the effect of increasing the rigidity of the connector support portion 15, which is an uneven plate-shaped portion, and in particular the effect of increasing the rigidity with respect to an outside force acting so as to twist the connector support portion 15.

As noted above, the connector 91 may be supported by the connector support portion 15 and may be fastened to a portion of the first frame portion 13. That is to say, the connector support portion 15 may support the connector 91 by engaging the coupling portion 92 formed on the outer surface of the connector 91 attached to the end of the wire 9.

### Pedestal Connector Support Portion

Referring to FIG. 14, the following is an explanation of a pedestal connector support portion 15A. FIG. 14 is a perspective view of such a pedestal connector support portion 15A in a wire fitting 10.

The pedestal connector support portion 15A may be constituted by a pedestal portion 103 that projects from a part of a base material 112, and the connector support portion 15 formed at the vertex of this pedestal portion 103. The structure of the connector support portion 15 is as described above.

In the pedestal connector support portion 15A formed on the wiring portion 11, the base material 112 may be the portion around the connector support portion 15A on the wiring portion 11. On the other hand, in the pedestal connector support portion 15A formed on the additional wire support portion 102, the base material 112 may be the portion around the connector support portion 15A on the additional wire support portion 102.

The pedestal portion 103 may be a hollow protrusion when seen from the side to which the connector 91 is attached. On the other hand, the pedestal portion 103 may be a recess when seen from the side opposite to the side to which the connector 91 is attached. The connector support portion 15A may be made by a vacuum molding process and a cutting process for forming the hole 153, the cut-in portions 154 and the eaves portion 1521.

### Effect

In the wire harness 100, the wires 9 may be sandwiched between the cover member 2 and the base member 1 constituting the wire fitting 10. Furthermore, the wires 9 arranged on the wiring portion 11 of the plate-shaped base member 1 may be fastened by wire tie portions 14 or connector support portions 15 at predetermined positions on the wiring portion 11.

Consequently, those portions of the wires 9 attached to the wire fitting 10 that are fastened by the wire tie portions 14 or the connector support portions 15 may be held at predetermined positions, and moreover, the length of the portions positioned outside from the portion fastened to the wire tie portions 14 may be held at a predetermined length. That is to say, the shape of the wires 9 may be held by the wire fitting 10 such that the ends of the wires 9 reach their connection counterparts at just the right length. Moreover, the wires 9 may be protected by the base member 1 and the cover member 2.

On the other hand, that portion of the wires 9 to which the wire fitting 10 is attached that is attached to the wiring portion 11, that is, the intermediate portion up to the first frame portion 13 of the base member 1 may be accommodated in the wiring space 90 without partitions between the wiring portion 11 occupying a region within the base member 1 and the opposing wall portion 21 occupying a region within the cover member 2.

Consequently, in the operation of laying out the wires 9 on the wiring portion 11 of the base member 1, the wires 9 may be laid out in arbitrary paths within the wiring portion 11, and even if the wires 9 are lifted up from the wiring portion 11, the wires 9 may be accommodated within the wiring space 90 between the wiring portion 11 and the opposing wall portion 21 simply by pushing the cover member 2 onto the base member 1. That is to say, a bothersome operation of laying out the wires 9 while pushing the wires 9 lifted up from the wiring portion 11 into the wiring portion 11 may not be necessary.

FIG. 8 is a cross-sectional view of a portion of the wire harness 100. The cross-sectional view in FIG. 8 shows the same portion of the wire fitting 10 as that shown in the cross-sectional view of FIG. 7. However, FIG. 8 is a cross-sectional view of a portion of the wire harness 100 in a state in which the wire fitting 10 may be fastened to a supporting member 7 in a state in which the side of the base member 1 faces the lower side of the supporting member 7.

As shown in FIGS. 7 and 8, the base member 1 and the cover member 2 may include a level wiring portion 11X and a level opposing wall portion 21X as well as a slanted wiring portion 11Y and a slanted opposing wall portion 21Y that are slanted with respect to the level wiring portion 11X and the level opposing wall portion 21X. Thus, the wire fitting 10 may be formed in a shape in which it is, on the whole, three-dimensionally bent. Therefore, such an arrangement may be suitable for cases in which the wire harness 100 including the wire fitting 10 is arranged within an automobile in an irregular space that is three-dimensionally bent.

For example, as shown in FIG. 8, in cases in which other devices 71, such as various types of structural objects or a motor, are present in the location where the wire fitting 10 is to be placed, the wire fitting 10 may be placed without contacting these other devices 71.

Furthermore, as shown in FIGS. 7 and 8, in the wire fitting 10, the wiring space 90 between the slanted wiring portion 11Y of the base member 1 and the slanted opposing wall portion 21Y of the cover member 2 may be partitioned with respect to the outside of the wiring space 90 by the first outer edge projecting portion 19 and the second outer edge projecting portion 29 opposing the same. With the first outer edge projecting portion 19 and the second outer edge projecting portion 29, it may be possible to prevent wires 9 from slipping between the slanted wiring portion 11Y of the base member 1 and the slanted opposing wall portion 21Y of the cover member 2 and sticking out.

Moreover, the first outer edge projecting portion 19 and the second outer edge projecting portion 29 may serve as a partition of the outer edge of the wiring space 90. Different to the ribs in the wire fitting of JP 2010-27242A, such a first outer edge projecting portion 19 and second outer edge projecting portion 29 do not easily overlap with the wires 9 laid out in the wiring space 90, and do not tend to become a factor in obstructing the suitable assembly of the cover member 2 with respect to the base member 1.

Moreover, in the wire fitting 10, the first step portion 12 of the base member 1 may function as a reinforcing portion that increases the rigidity of the uneven plate-shaped base member 1. Similarly, also the second step portion 22 of the cover member 2 may function as a reinforcing portion that increases the rigidity of the uneven plate-shaped cover member 2.

In particular, with the first connecting step portion 121 (reinforcement step portion), which may be formed from the level wiring portion 11X to the slanted wiring portion 11Y, the rigidity for holding the slant angle of the slanted wiring portion 11Y with respect to the level wiring portion 11X may be increased. Therefore, the base member 1 and the cover member 2 may ensure a high rigidity, even when their thickness is made comparatively small in order to save space and reduce weight. Consequently, even if the wire fitting 10 uses plate-shaped members with comparatively small thickness in order to save space and reduce weight, the ability to maintain a constant shape (rigidity) may be high.

It should be noted that also the second connecting step portion 221 formed in the cover member 2 from the level opposing wall portion 21X to the slanted opposing wall portion 21Y may have the same role as the first connecting step portion 121.

Moreover, the first step portion 12, the first outer edge projecting portion 19, the second step portion 22 and the second outer edge projecting portion 29 may project forming side walls without an undercut when viewed from direction E or F that are perpendicular to planes parallel to the level wiring portion 11X and the level opposing wall portion 21X. Therefore, the base member 1 and the cover member 2 may be manufactured with a simple molding process using a die that moves back and forth in only one direction and without a complicated molding process using a sliding die, for example with a single vacuum molding process.

As shown above, with the exemplary embodiments, it may be possible to arrange the wire fitting 10 of the wire harness 100 in an irregular space that is three-dimensionally bent, and furthermore, to reduce the number of man-hours for assembling the wire fitting 10 to the wires 9. Furthermore, the number of man-hours for manufacturing the wire fitting 10 may be reduced.

Generally, members obtained by vacuum-molding flat plate-shaped members can be manufactured more easily and at lower cost than members that are obtained by injection molding of resin. The wire fitting 10 may be a member that can be obtained by vacuum-molding of flat plate-shaped members, so that the manufacturing time and manufacturing costs may be reduced.

### Further Considerations

In the wire fitting 10, the tie belt 8 that may be passed through the through hole 142 in the wire tie portion 14 does not come off from the first frame portion 13 of the base member 1, so it may be possible to prevent the tie belt 8 from coming off from the first frame portion 13 of the base member 1 and the tying of the wires 9 is loosened. Moreover, the length of the wires 9 form the portion that may be fastened with the tie belt 8 to their terminal end can be held at a predetermined length.

Moreover, since the wire tie portion 14 may be provided with a projection 144, the tie belt 8 can hardly be bent sharply at the edge of the through hole 142 and the edge of the cut-in portion 143. That is to say, the tie belt 8 may tie the wire passing portion 141 and the wires 9 together with a shape that is closer to being circular. As a result, becomes possible to fasten the wires 9 more tightly with the tie belt 8.

Moreover, in the wire fitting 10, the connector support portion 15 may support the connector 91 by engaging the coupling portion 92 of the connector 91 at the end of a wire 9. Thus, the connector 91 at the end of the wire 9 may be fastened at a predetermined position of the base member 1 by a very simple operation.

Moreover, in the connector support portion 15, the connector 91 at the end of the wire 9 may be fastened to the connector support portion 15 by fitting the pair of guide rail portions 921 of the coupling portion 92 into the grooves of the pair of parallel recesses 151, fitting the intermediate plate portion 152 into the gap between the bridge portion 922 of the coupling portion 92 and the outer surface of the connector 91, and fitting the opposing protrusion 923 of the coupling portion 92 into the hole 153 of the intermediate plate portion 152.

Moreover, due to the slight flexing of the portion with the pair of parallel recesses 151 and the intermediate plate portion 152 in the connector support portion 15, the connectors 91 may be fastened in a state in which they are in close contact with the connector support portions 15, that is, in a state without play. Therefore, the connector support portions 15 and the connectors 91 supported by them may not generate any abnormal noise, even when subject to vibrations.

Moreover, by employing pedestal connector support portions 15A, it may be possible to arrange the fastening portions of the connectors 91 at positions of any height with respect to the base material. Therefore, even if the wires 9 are arranged along a path that is removed from the base material in order to avoid contact with other devices 71, it may be possible to position the fastening portions of the connectors 91 at positions corresponding to the path of the wires 9. That is to say, the overall position of the wire fitting 10 and the positions of the fastening portions of the connectors 91 may be set individually, increasing the degree of freedom for the wiring.

Also, the connector support portion 15 and the pedestal connector support portion 15A may be constituted by members that are molded into an uneven plate shape. Such members may be obtained by vacuum-molding flat plate-shaped resin members or by injection molding using a simple die without a slide mechanism, so that the time and costs required for manufacturing them are low.

Moreover, in the connector support portion 15 of the wire fitting 10, the border portions between the two sides of the intermediate plate portion 152 and the respective parallel recesses may be formed by cutting inward. Thus, the intermediate plate portion 152 may be latched in a more stable state to the bridge portion 922 at the coupling portion 92 of the connector 91, and the connector 91 may not easily come off from the connector support portion 15.

Moreover, in the connector support portion 15 of the wire fitting 10, an inner recess 155 may be formed in a portion forming a groove that connects the pair of grooves. Thus, the rigidity of the connector support portion 15 in the wire fitting 10, which is an uneven plate-shaped member, may be increased.

Also, in the base member 1 of the wire fitting 10, it may be possible to use a flat wiring portion 11 in which no reinforcement recesses 111 are formed. Furthermore, it is also possible that protrusions or grooves that are connected in a lattice shape or a net-like shape may be formed in the wiring portion 11 of the base member 1. Also such protrusions or grooves may have the effect of increasing the rigidity of the wiring portion 11.

Moreover, it is possible that the base member 1 and the cover member 2 are obtained by injection molding of resin. However, the wire fitting 10 may be a member that is molded into an uneven plate shape only in vertical direction (extending in a single dimension), and may be a member that can be obtained easily by vacuum molding a plate-shaped resin member. Consequently, in view of the manufacturing time and manufacturing costs, it may be desirable that the wire fitting 10 is a vacuum-molded flat plate-shaped member.

The foregoing descriptions of specific embodiments have been presented for purposes of illustration and description. They are not intended to be exhaustive or to limit the invention to the precise forms disclosed, and obviously many modifications and variations are possible in light of the above teaching. The embodiments were chosen and described in order to best explain principles and practical applications of the invention, and to thereby enable others skilled in the art to best utilize the invention and various embodiments with various modifications as are suited to the particular use contemplated. It is understood that various omissions and substitutions of equivalents are contemplated as circumstances may suggest or render expedient, but these are intended to cover the application or implementation without departing from the spirit or scope of the claims of the present invention.

What is claimed is:

1. A wire fitting comprising:
a base member that is a plate shape forming a wiring space, the base member having a wire fastening portion to which one or more wires can be fastened; and
a cover member that is a plate shape, such that the cover member is assembled to the base member across the wiring space,
wherein the base member comprises:
a level bottom plate portion that extends along a plane that is parallel to a first plane;
a slanted bottom plate portion that is continuous with the level bottom plate portion, and that extends along a second plane that is slanted with respect to the first plane;
a first outer edge projecting portion that is located in a portion of the slanted bottom plate portion and that projects from the slanted bottom plate portion creating a side wall without an undercut when viewed from a direction perpendicular to the first plane, the first outer edge projecting portion constituting a partition at an outer edge of the wiring space; and
the cover member comprises:
a level ceiling plate portion that extends along a plane that is parallel to a third plane, the level ceiling plate portion being arranged opposite the level bottom plate portion across the wiring space;
a slanted ceiling plate portion that is continuous with the level ceiling plate portion, and that extends along a fourth plane that is slanted with respect to the third plane, the slanted ceiling plate portion being arranged opposite the slanted bottom plate portion across the wiring space; and
a second outer edge projecting portion that is located at a location of the slanted ceiling plate portion opposite the first outer edge projecting portion, the second outer edge projecting portion projecting from the slanted ceiling plate portion toward the first outer edge projecting portion creating a side wall without an undercut when viewed from a direction perpendicular to the third plane, the second outer edge projecting portion constituting a partition at an outer edge of the wiring space together with the first outer edge projecting portion.

2. The wire fitting according to claim 1,
wherein the base member further comprises a reinforcement step portion that is continuous from the level bottom plate portion to the slanted bottom plate portion and where the reinforcement step portion constitutes a step surface without an undercut when viewed from a direction perpendicular to the first plane.

3. The wire fitting according to claim 1,
wherein the base member and the cover member are vacuum-molded flat plate-shaped resin members.

4. The wire fitting according to claim 2,
wherein the base member and the cover member are vacuum-molded flat plate-shaped resin members.

5. The wire fitting according to claim 3,
wherein the base member and the cover member are vacuum-molded flat plate-shaped members made of polyvinylchloride, polypropylene or polyethylene-terephthalate.

6. The wire fitting according to claim 4,
wherein the base member and the cover member are vacuum-molded flat plate-shaped members made of polyvinylchloride, polypropylene or polyethylene-terephthalate.

7. The wire fitting according to claim 1,
wherein the base member and the cover member further comprise a plurality of preliminary fixing recesses and a plurality of preliminary fixing protrusions, and
the preliminary fixing protrusions are pushed into the preliminary fixing recesses in order to fix the cover member with respect to the base member in a state in which the cover member covers the wire fastening portion due to the friction resistance between the side walls of the preliminary fixing protrusions and the inner walls of the preliminary fixing recesses.

8. The wire fitting according to claim 7,
further comprising a welded portion between the preliminary fixing protrusions and the preliminary fixing recesses.

9. A wire harness comprising:
one or more wires; and
a wire fitting including a base member that is a plate shape forming a wiring space, the base member having a wire fastening portion to which a portion of the wires can be fastened, and a cover member that is a plate shape, the cover member being assembled to the base member across the wiring space,
wherein the base member of the wire fitting comprises:
a level bottom plate portion that extends along a plane that is parallel to a first plane;
a slanted bottom plate portion that is continuous with the level bottom plate portion, and that extends along a second plane that is slanted with respect to the first plane;
a first outer edge projecting portion that is located in a portion of the slanted bottom plate portion and that projects from the slanted bottom plate portion creating a side wall without an undercut when viewed from a direction perpendicular to the first plane, the first outer edge projecting portion constituting a partition at an outer edge of the wiring space; and
the cover member of the wire fitting comprises:
a level ceiling plate portion that extends along a plane that is parallel to a third plane, the level ceiling plate portion being arranged opposite the level bottom plate portion across the wiring space;
a slanted ceiling plate portion that is continuous with the level ceiling plate portion, and that extends along a fourth plane that is slanted with respect to the third plane, the slanted ceiling plate portion being arranged opposite the slanted bottom plate portion across the wiring space; and
a second outer edge projecting portion that is located at a location of the slanted ceiling plate portion opposite the first outer edge projecting portion, the second outer edge projecting portion projecting from the slanted ceiling plate portion toward the first outer edge projecting portion creating a side wall without an undercut when viewed from a direction perpendicular to the third plane, the second outer edge projecting portion constituting a partition at an outer edge of the wiring space together with the first outer edge projecting portion.
